(19) United States
(12) Patent Application Publication
(10) Pub. No.: US 2012/0173442 A1
(43) Pub. Date: Jul. 5, 2012

(54) System and method for intellectual property prosecution management

(76) Inventors: Savi Gupta, New Delhi (IN); Balwant Rawat, Gurgaon (IN)

(21) Appl. No.: 13/374,658

(22) Filed: Jan. 5, 2012

(30) Foreign Application Priority Data
Jan. 5, 2011 (IN) 23/DEL/2011

(51) Int. Cl. G06Q 50/00

(52) U.S. Cl. 705/310

(57) ABSTRACT

A system is provided for Intellectual Property (IP) prosecution management. The system includes a workflow engine that is configured to provide access to one or more IP documents stored in a database by one or more users. The workflow engine is configured to facilitate online IP prosecution support based on the access of the one or more IP documents.

### CROSS REFERENCE TO RELATED APPLICATION

This application claims priority from the provisional application no.: 23/DEL/2011 titled: “System and Method for Intellectual Property Prosecution Management” filed with the Indian patent office on Jan. 5, 2011.

### FIELD OF INVENTION

The present invention relates, generally, to Intellectual Property (IP) asset management. More specifically, the present invention relates to a method, a system, and a computer program product for IP prosecution management.

### BACKGROUND OF INVENTION

In today's globalized economy, Intellectual Property (IP) owners are increasingly protecting their intellectual property across multiple countries. Even after a number of international agreements and conventions, the IP laws, procedures and regulations differ across different countries. Such diverse IP laws and procedures put an additional burden on the IP owners to adhere to country specific requirements. For example, patent laws in many countries require applicants to update the respective patent offices with all prior art relevant to the invention, whether known prior to filing the patent application or uncovered during examination of the corresponding family applications.

In yet another example, Title 37 of the Code of Federal Regulations (37 C.F.R.) United States makes it obligatory on the part of a patent applicant or any other person associated with the filing or prosecution of a patent application to disclose all information, which is material to the patentability of an invention, to the United States Patent Office (USPTO). If such information is not disclosed to the USPTO, the patent can be revoked or the application can be rejected. The list of such prior arts needs to be submitted to the USPTO in a specified form called Information Disclosure Statement (IDS) form (SB08). The IDS form needs to be submitted by the applicant at the time of filing the patent application or within three months of filing. Supplemental IDS can also be filed during the course of prosecution if any new art is discovered or cited by examiners in the corresponding family applications. Corresponding family applications mean patent applications filed for protecting the same invention in other countries/jurisdictions. In such cases, the foreign patent offices conduct independent patent searches to examine respective patent applications, and may issue search reports or cite prior arts in the respective office action reports. Any new prior art cited in these reports need to be reported by the applicant to the USPTO. While filing an IDS with the USPTO, copies of the non-US patents and non-patent prior art need to be filed together with English translations, wherever applicable.

In another example, under the European patent law, the recently introduced Rule 141 and new Rule 70b require applicants claiming priority from an international patent application to share search results of the office of first filing with the European Patent Office (EPO). Additionally, under Article 124 EPC read in combination with Rule 141 EPC, the EP examiners can invite applicants to provide information on prior art taken into consideration in national or regional patent proceedings at any time during the course of prosecution of the European patent application.

In another example, under Section 8 of Indian Patent Act 1970, an applicant needs to file a statement setting out detailed particulars of corresponding family applications with the Indian Patent Office (IPO), as well as update the IPO about the office actions, citations in the office action, and any communications issued by the respective patent offices in the corresponding foreign applications. The above statement and details need to be filed with the IPO in the specified Form 3.

In the example above, the prior art disclosure requirements are also applicable to some other countries such as Canada and Israel. Non compliance to these prior disclosure requirements can have adverse impact on the validity of patent. For instance, in the US, irregularity in complying with this law (37 C.F.R.) amounts to inequitable conduct. There have been numerous court cases of patent infringements where defendants have successfully identified and asserted this inequitable conduct to render the patent unenforceable.

It is, therefore, important to track IP documents and manage it, so as to comply with IP office requirements worldwide. The management of IP documents become complex with the increasing size of the IP portfolios. The complexity and associated risk of non-compliance grow multi-fold when IP owners have big portfolios spread across multiple countries and continents.

### SUMMARY

Embodiments of a method are described for Intellectual Property (IP) prosecution management. The method comprises maintaining a database of one or more IP documents, where the IP documents comprise one or more IP deliverables. The method further comprises accessing the database based on a user input. Furthermore, the method comprises performing one or more IP processing activities, associated with the one or more IP documents, based on the user input.

Embodiments of a system are described for Intellectual Property (IP) prosecution management. The system comprises a workflow engine that is configured to provide access to one or more IP documents stored in a database. Further, the workflow engine is configured to facilitate online IP prosecution support based on the access of the one or more IP documents.

### BRIEF DESCRIPTION OF FIGURES

The following detailed description of the embodiments of the disclosed invention will be better understood when read with reference to the appended drawings. The invention is illustrated by way of example, and is not limited by the accompanying figures, in which like references indicate similar elements.

FIG. 1 illustrates a diagram for a system environment 100 for intellectual property (IP) prosecution management in accordance with an embodiment of the invention;

FIG. 2 illustrates a system for managing intellectual property prosecution in accordance with an embodiment of the invention;

FIG. 3 illustrates an exemplary diagram of a user interface for displaying various modules for user selection, in accordance with an embodiment of the invention;

FIG. 4 illustrates an exemplary diagram of an authentication interface for authentication of users accessing intellectual property management system in accordance with an embodiment of the invention;

FIG. 5 illustrates an exemplary diagram of an order interface for procuring. IP documents from a database in accordance with an embodiment of the invention;.

FIG. 6 illustrates an exemplary diagram of an upload interface for uploading IP documents to a database in accordance with an embodiment of the invention;

FIG. 7 illustrates an exemplary diagram of a search interface, for searching IP documents on a database in accordance with an embodiment of the invention;

FIG. 8 illustrates an exemplary diagram of an alternate system environment for Intellectual Property (IP) prosecution management in accordance with an embodiment of the invention; and

FIG. 9 illustrates a flowchart 900 illustrating a method for managing Intellectual Property prosecution in accordance with an embodiment of the invention.

The system and the method components have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

### DE-TAILED DESCRIPTION

The present invention can be best understood with reference to the detailed figures and description set forth herein. Various embodiments are discussed below with reference to the figures. However, those skilled in the art will readily appreciate that the detailed description given herein with respect to these figures is just for explanatory purposes as methods and systems, of the invention, extend beyond the described embodiments. For example, those skilled in the art will appreciate that in light of the teachings presented, multiple alternate and suitable approaches can be recognized, depending on the needs of a particular application, to implement the functionality of any detail described herein, beyond the particular implementation choices in the following embodiments described and shown.

Various embodiments of the invention provide a method and a system for management of Intellectual Property (IP) documents in a IP prosecution lifecycle. IP documents include all documents relevant to the filing, prosecution and maintenance of IP applications, such as application-as-filed, application forms, prior art documents identified by an application or the IP examiners, etc.

### Definition of Terms

IP documents: IP documents corresponds to all documents relevant to the filing, prosecution and maintenance of IP applications, such as application as filed, application forms, prior art documents identified by an application or the IP examiners.

IP Prosecution: IP prosecution corresponds to the interaction between applicants, or their representatives and an IP office regarding the grant of intellectual property rights.

IP Offices: IP offices correspond to federal bodies capable of granting Intellectual property rights. IP Offices may include one or more of patent offices, trademark offices, copyright offices, etc.

IP office communication: IP office communication corresponds to communications issued by an examiner during an IP examination procedure.

IP dockets: IP Docket corresponds to a numerical system that keeps a track of IP documents and IP office communications to help the associated applicant/party in keeping a track of important legal deadlines.

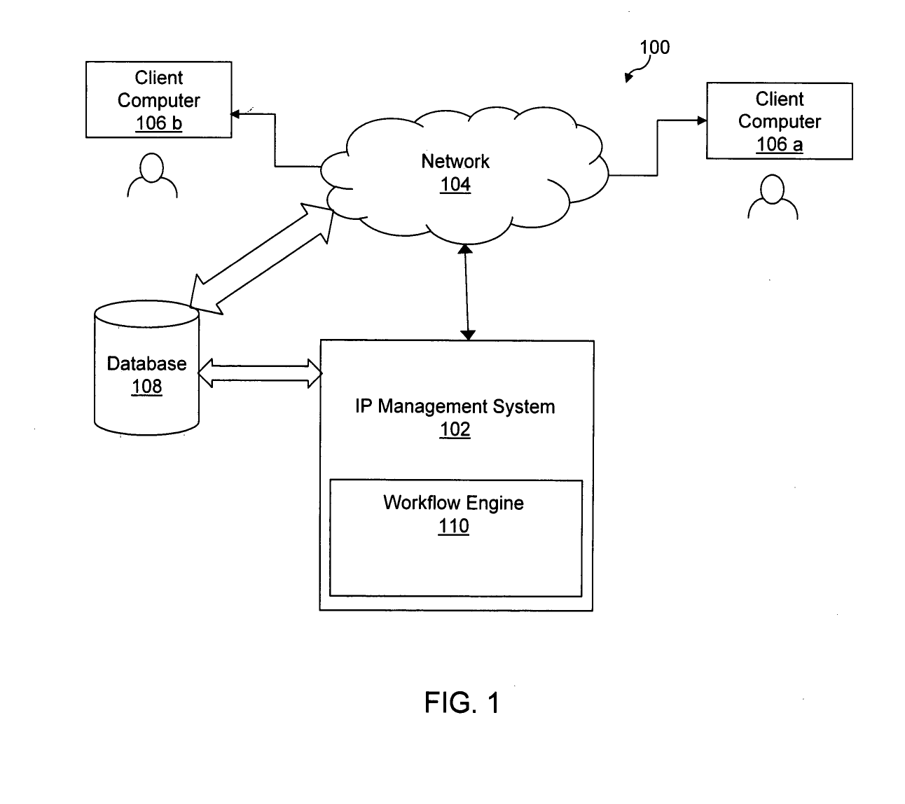

FIG. 1 illustrates a block diagram of a system environment 100 for intellectual property (IP) prosecution management, more specifically management of IP documents, with an embodiment of the invention. The system environment 100 includes an intellectual property (IP) prosecution management system 102, hereinafter referred to as a system 102, a network 104, client computers 106a-106n, and a database 108. The system 102 further includes a workflow engine 110. The system 102 can be used to accomplish any one or more aspects of ordering, searching, or uploading of one or more IP documents as described in, and apparent from the embodiments provided herein. The system 102 corresponds to a computing device that includes, but not limited to, a computer, a server, a digital signal processing device, etc., capable of storing one or more program instructions for implementing the invention.

The Network 104 corresponds to a medium through which the one or more IP documents can be accessed at time of performance of one or more aspects of ordering, searching, and uploading of the one or more IP documents. Examples of the network 104 may include, but not limited to a Wireless Fidelity (WiFi) network, a Wireless Area Network (WAN), a Local Area Network (LAN), a Metropolitan Area Network (MAN), a Virtual Private Network (VPN), the internet, or a combinations of various networks. Various devices in the system environment 100 can connect to the network 104 in accordance with various wired and wireless communication protocols, such as Transmission Control Protocol and Internet Protocol (TCP/IP), User Datagram Protocol (UDP), 2G, 3G, or 4 G communication protocols.

A user can subscribe on the system 102 using the client computer 106a. The system 102 provides the users with a means for accessing the various functionalities associated with IP prosecution management. The client computer 106a can be any computing device. Examples of the client computer 106a may include, but not limiting to, personal computers, laptops, Personal Digital Assistants (PDAs), tablet computers, mobile phones, Internet-based devices, portable or handheld electronic devices, or any other device having hardware and software components.

The database 108 can store any IP related information, such as IP documents, deliverables, country-specific templates, or important prosecution dates. Information may be stored in the database 108 as a continuous set of data, segmented to form a contiguous whole, or separated into different segments to reside in and among one or more databases, as well as partitioned for storage in one or more files to achieve efficiency in storage, accessing, and processing of data records. Format of data storage may be ASCII text, comma delimited ACT, EXCEL, ACCESS, TEXT, DBASE, or other database formats.

The workflow engine 110 is responsible for the control of logic within the system 102 to provide the IP processing activities. System 102 is connected to a network 104 that enables the system 102 to communicate with one or more client computers 106a-106b.

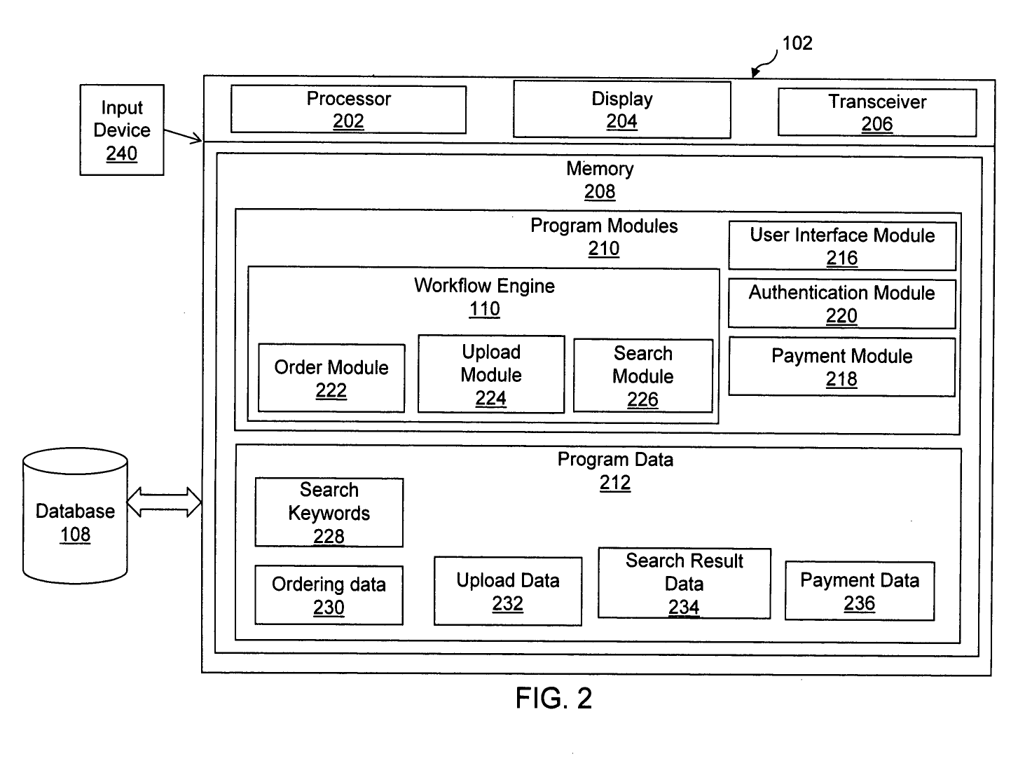

FIG. 2 illustrates a system 102 for managing intellectual property prosecution and IP documents. The system 102 includes a processor 202, a display 204, a transceiver 206, and a memory 208.

The processor 202 is configured to execute a set of instructions stored in the memory 208. The processor 202 can be realized through a number of processor technologies known in the art. Examples of the processor 202 can be X86 processor, RISC processor, ASIC processor, CSIC processor, or any other processor. The processor 202 fetches the set of instructions from the memory 208 and executes the set of instructions.

The display 204 is configured to display information to one or more users. The display 204 can be a conventional black and white, monochrome, or color display elements including Cathode Ray Tube (CRT), Thin Film Transistor (TFT), Liquid Crystal Display (LCD), Retina Display technology, and/or Light Emitting Diode (LED) display devices. Further, the display 204 may be a touch screen display that is capable to receive a user input.

The transceiver 206 is configured to transmit and receive data. The transceiver 206 transmits and receives data in accordance with various communication protocols such as Transmission Control Protocol and Internet Protocol (TCP/IP), User Datagram Protocol (UDP), 2G, 3G and 4G communication protocols.

The memory 208 is configured to store a set of instructions or modules. Some of the commonly known memory device implementations can be, but not limited to, a random access memory (RAM), read only memory (ROM), hard disk drive (HDD), and secure digital (SD) card.

Further, the memory 208 includes two partitions, where a first partition includes program modules 210 and the second partition includes program data 212. The program module 210 includes a set of instructions that can be executed by the processor 202 to perform specific processes on the display 204. Program modules 210 are individual modules that may be one or more logical, self-contained, and discretely executable programs.

Program modules 210 further includes a workflow engine 110, user interface module 216, authentication module 220, and payment module 218. The workflow engine 110 is responsible for the control of logic within the system 102 to provide IP processing activities, thus facilitating online IP prosecution management support and providing a platform to the users for accessing IP documents stored in the database 108.

Workflow engine 110 in general governs the access, retrieval, and upload of IP documents to the database 108. Further, the workflow engine 110 facilitates online IP prosecution support. Furthermore, workflow engine 110 enables access to one or more IP documents stored in the database 110. User interface module 216 is configured to capture and present the user inputs from the input device 240. Authentication module 220 provides the users an option to login on the system 102 with specific and unique credentials. User interface module 216 facilitates interaction of one or more users with the database 108 and system 102 via the input device 240, and display 204. Payment module 218 calculates specific fees incurred while working on the database 108 for a specific authenticated login.

Workflow engine 110 further includes order module 222, upload module 224, and search module 226. When a user gets subscribed, the user can login on the system 102 and access the database 108, or avail one or more IP processing activities provided by the workflow engine 110. Order module 222 includes a logic to provide IP processing activities to enable the subscribed users to order for procuring copies of one or more IP documents, request a review of an office action to identify new prior art citations, and order formalities/templates support to prepare and file forms with IP offices. The upload module 224 includes logic to allow users to upload/transfer one or more IP documents from a client computer 106a to the database 108. Search module 226 includes logic to provide users search and access functionality on one or more IP documents stored in the database 108.

Input device 240 is configured to receive a user input. Examples of the input device 240 may be, but not limited to, a keyboard, a mouse, a joystick, a gamepad, a stylus, or a touch screen.

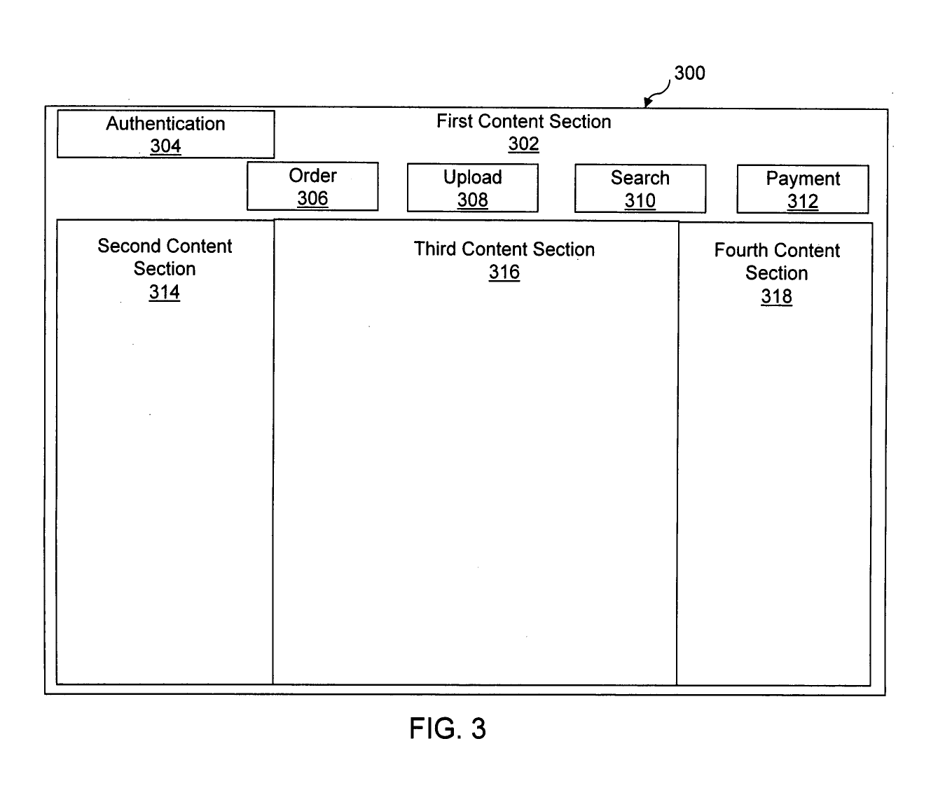

In operation, a user fills authentication details on the authentication interface 300 of FIG. 3. These credentials are verified by the authentication module 220. In case of a successful authentication, the user is provided access to the system 102 and the database 108. In case of a failed authentication, the user is denied access to the system 102. Further, the user is provided with options to choose from the program modules 210 functionalities.

FIG. 3 illustrates a user interface for selection of the functionalities provided by the program modules 210 in accordance with an embodiment of the invention. The user interface 300 is generated by the user interface module 216. In an embodiment, the user interface 300 includes a first content section 302 that displays a number of clickable tabs, such as an authentication options tab 304, an order tab 306, an upload tab 308, a search tab 310, and a payment tab 312. The function of the clickable tab corresponds to functionalities provided by the respective program modules. Therefore, the authentication options tab 304, the order tab 306, the upload tab 308, the search tab 310, and the payment tab 312 correspond to functionalities provided by authentication module 220, order module 222, upload module 224, search module 226 and payment module 218 respectively. On clicking on the clickable tabs the respective functionality can be utilized by a user.

User interface 300 further includes a second content section 314, a third content section 316, and a fourth content section 318. The second content section 314 may provide a list of operations and help file documents that can be performed by the system 102. The third content section 316 may provide news information related to Intellectual property. The fourth content section 318 may provide settings for the interface that may be customized according to user preferences. For example, customization can be done by changing color, font size, arrangement of clickable tabs, etc.

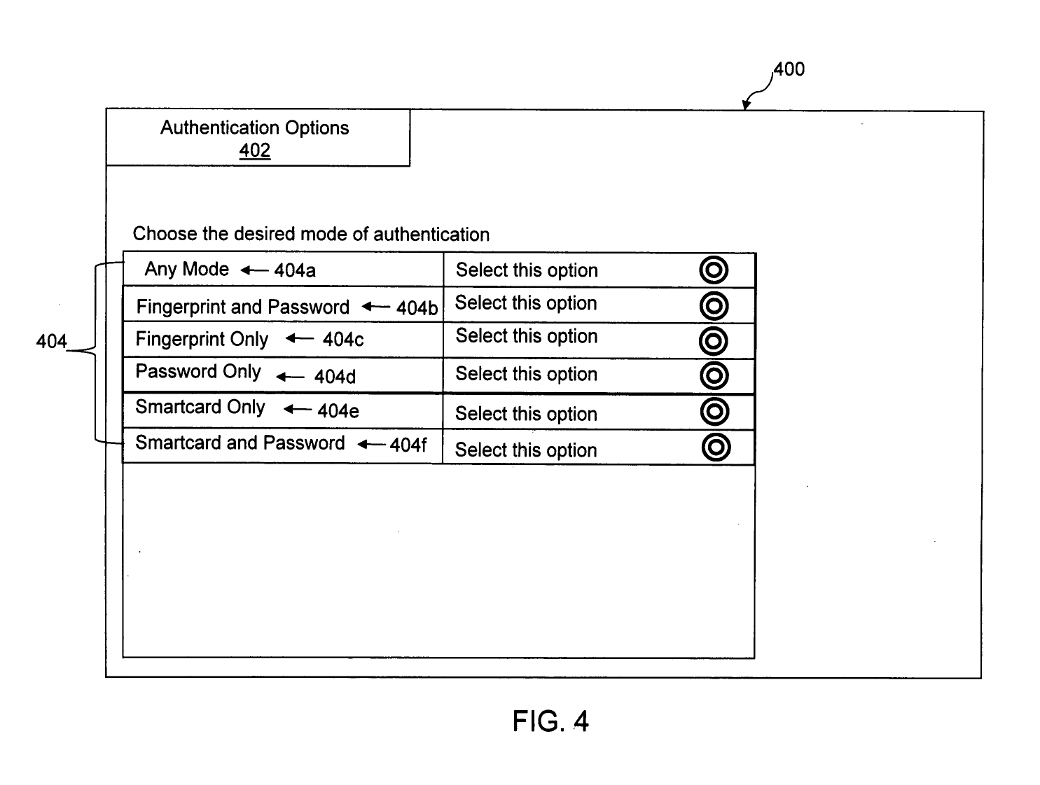

FIG. 4 illustrates an exemplary diagram of an authentication interface 400 for authentication of users accessing the system 102. Authentication interface 400 includes a clickable authentication options tab 402. The authentication options tab 402 provides a number of authentication policy choices 404. Upon selecting the authentication options tab 402, a list 404a-404f of authentication policy choices is displayed to the user. Some of the choices 404c, 404d include choices that comprise a single authentication policy, such as fingerprint only choice 404c, password only choice 404d, etc. Authentication policy choices 404 further includes multiple modes of authentication choices. Examples of multiple modes of authentication choices comprise the fingerprint and password choice 404b, and the smartcard and password choice 404f. Authentication module 220 compares authentication details provided by users on the authentication interface with the credentials stored in the database 108 to determine if a match exists. If a match exists, the user is considered as authenticated. If a match does not exist, the user is not authenticated and access is denied to the system 102.

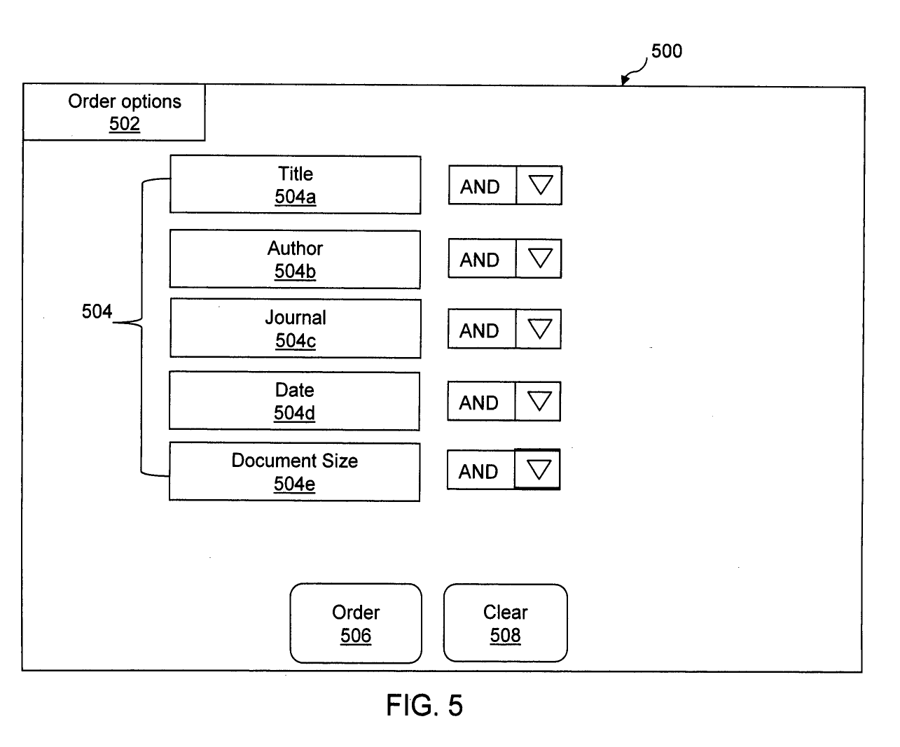

FIG. 5 illustrates an exemplary diagram of an order interface 500 for procuring IP documents from the database 108. After the authentication has been provided to a user, clicking on the order options tab 502 provides the order module 222 functionality to users so as to order copies of one or more IP documents from the database 108. For example, consider a scenario where a user (e.g., an IP attorney or an applicant) needs to obtain a copy of a prior art relevant for a pending IP application. When the user clicks order options tab, bibliographic details tabs 504 are displayed having one or more of the fields 504a-504e, along with order tab 506, and clear tab 508. The bibliographic details tabs 504 may include one or more, but not limiting to, title 504a, author 504b, journal 504c, date of the document 504d and document size 504e. Upon submitting the order information by clicking the order tab 506, the system 102 checks if the document is already available in the database 108. If the document is available, the document is displayed on the screen of client computer 106a to the user, who can then associate the document with a docket ID. If the document is not available, a request to procure the document is sent automatically to a paralegal at a back-end or directly to a document procurement vendor. The paralegal, after obtaining the copy of the document, may upload the copy of the document and fill the relevant metadata (such as docket id and relevant bibliographic information). When the user wants to order new documents, then the user can click on the clear tab 530 to clear fields 505a-504e of bibliographic details tabs 504 and can repeat the above described procedure. The ordered data is then stored in the order data 230. In an embodiment of the invention, the paralegal can check for copyright restriction and can obtain necessary copyright license to upload the document with view/download rights restricted to the specified user(s) only. For example, some IP offices require a translated copy of the IP document, if the document is not in the native language. In such case, the user may order a translation of the document on the order interface 500. The translation can be performed manually by human professionals or by computing means.

In an embodiment of the present invention, the user may also order review of the IP office communication. For example, the user may submit a Patent Cooperation Treaty (PCT) search report for a US patent application to identify any new prior art document. The PCT provides a unified procedure for filing patent applications to protect inventions in each of its contracting states. The paralegal, after receiving the request, can identify the prior arts listed in the search report and map them against the prior arts previously disclosed to the US patent office. Any new prior art thus identified may be reported to the user by the paralegal. In an embodiment, the step of mapping listed arts can be performed automatically by system 102 by comparing them with the previously disclosed arts uploaded in the database 108.

According to an embodiment of the present invention, the user may request preparation of formal documents for disclosing prior art to the relevant IP office (e.g. patent office). One example of such formal documents includes preparing SB-08 IDS form (first IDS or supplementary IDS). The user may specify the list of relevant prior arts at order module 222 and the details of the IP application for which the formal document needs to be prepared. Upon submission of the request, an acknowledgement can be sent to the user, and the request is forwarded to the concerned paralegal for preparation/filing of the formal documents that disclose one or more prior arts to a relevant LP office. The formal documents can either be sent to the user via an email or can be uploaded in the database 108 in a deliverable section (not shown in figures). Further, the order module 222 is configured to order one or more IP office communications to identify new IP documents, or order a copy of one or more IP documents, where the copy corresponds to IP documents stored in the database 108 subsequent to a request for procurement.

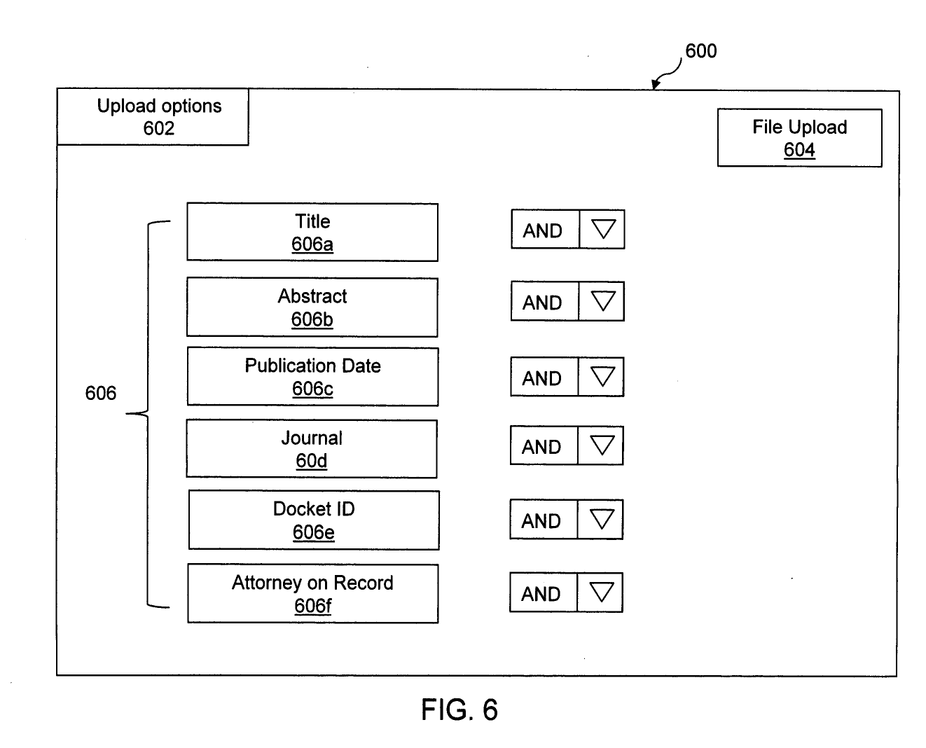

FIG. 6 illustrates an exemplary diagram of upload interface 600 for uploading IP documents to the database 108 by an upload module 224. The upload interface 600 includes an upload options tab 602. The upload interface 600 is adapted to receive an electronic document and deliverables for storing in database 108 by the functionality of upload module 224. On clicking the upload options tab 602, a list of identification details tags 606, such as title 606a, abstract 606b, publication date 606c, journal names 606d, docket id 606e, attorney-on-record 606f, country of publication (not shown in figures), publication number (not shown in figures), copyright status (not shown in figures), and cost information (not shown in figures) are displayed along with the file upload tab 604. The tags, such as docket id (604e), attorney-on-record (604f), and cost information (not shown in figures), are useful for an IP law firm or in-house counsel in case of invoicing and tracking expenses per attorney per docket. Upload tab is capable of uploading deliverables resulting from requests for preparation of formal documents or requests for reviewing of the IP office communication. Further, the upload module 224 functionality provided on the upload interface 600 uploads one or more deliverables prepared on a request basis.

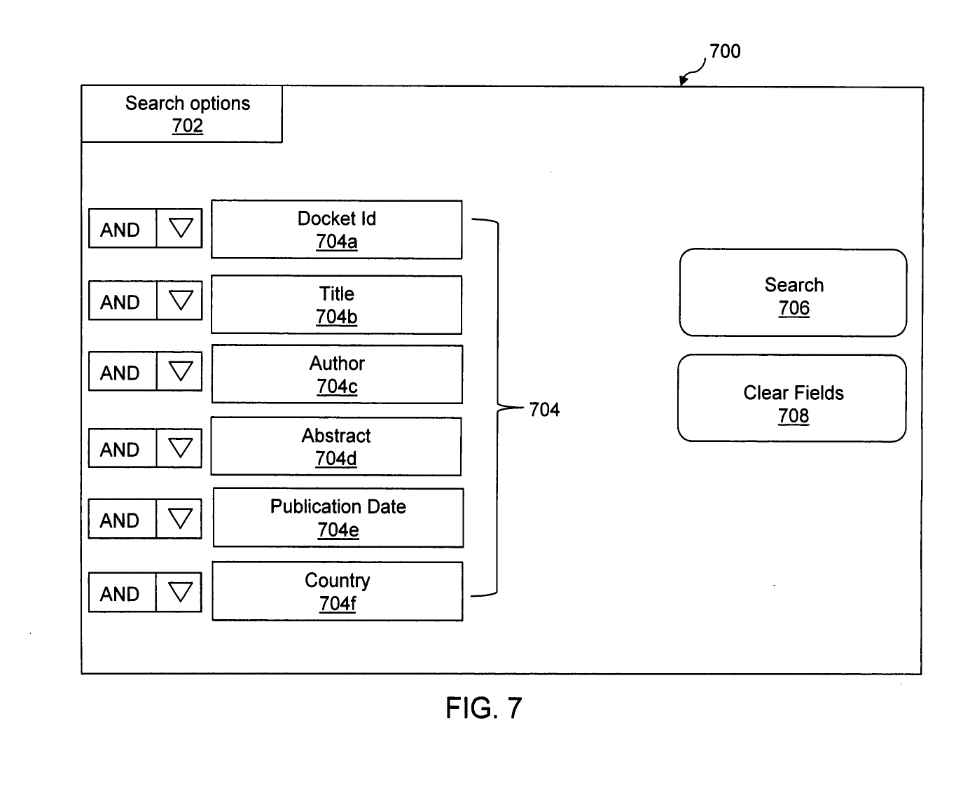

FIG. 7 illustrates an exemplary diagram of search interface 700, for searching IP documents on the database 108. Search interface 700 enables searching and accessing details of IP documents stored in database 108 by clicking on search options using search parameter tabs 704, such as docket id 704a, title 704b, author 704c, abstract 704d, publication date 704e, and country 704f. Search interface provides the associated functionality of search module 226 to the users. In an embodiment, search module 226 also allows full-text searching inside the documents stored in the database 108. Search module 226 is programmed to gain access to underlying data stored in the database 108 of a classification system based on search parameters.

Search module 226 receives input data from a user via input device 240 regarding one or more search parameter tabs 704 selected by the user. The different forms of input parameters available may be selected individually, in combinations, or all at once, as desired by a user. The search module 226 is programmed to display search results from individual classifications separately, ordered in any preference designated by the user (e.g., docket id 704a, title 704b, author 704c, abstract 704d, publication date 704e, and country 704f, inventor (not shown in figures) etc.). A user may alternatively request that search module 226 present any two or more selected classification parameters as a simultaneous listing or single grouping of search results (ordered as desired), with removal of any duplicates arising from commonly classified documents or information.

Search interface 700 is programmed to permit a user to further define or otherwise edit the search criteria to refine or limit the search results. Other search criteria or queries performed by search module 226 can be added to search criteria stored in search result data 234 (or at least searched in conjunction with the stored search criteria) to effectively narrow the focus of the search. The search tab 706 allows a user to perform search and the clear fields tab 708 allows the user to enter new search keywords for a new search operation. Search keywords can be stored in the search keywords 228. Similarly, search result data is stored in the search result data 234.

According to an embodiment of the present invention, workflow engine 110 can also have functionalities, such as sending automatic acknowledgment to requestors; viewing order history, different login for different users and associated variable access level rights; storing and archiving deliverables (such as reviewed office actions and formal documents).

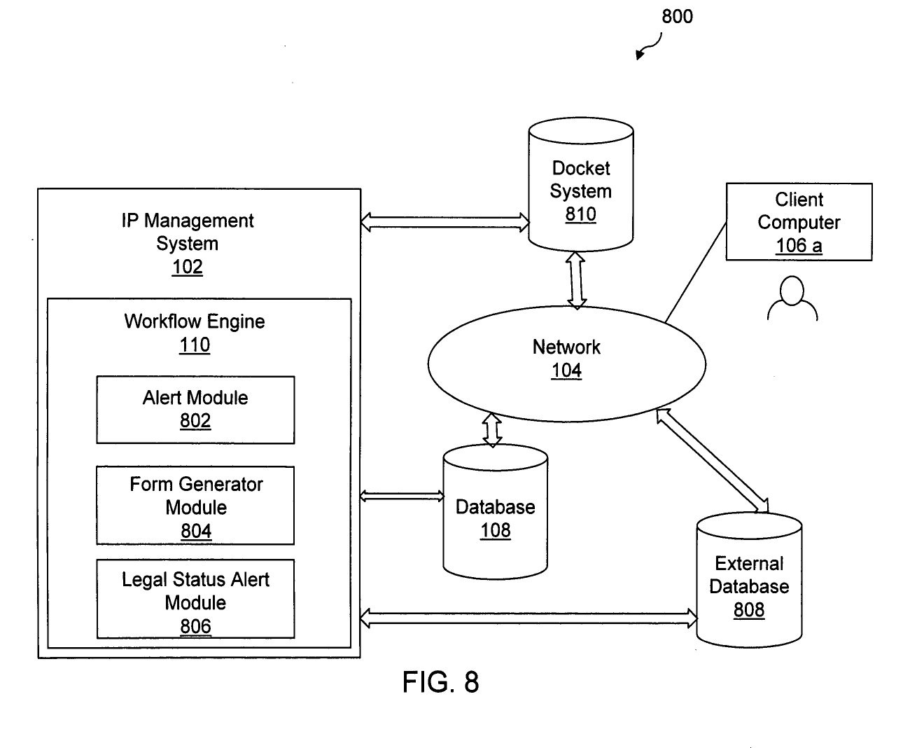

FIG. 8 illustrates an exemplary diagram of an alternate system environment 800 for intellectual property prosecution management. In an alternate embodiment of the present invention, the system environment 800 includes the system 102, the network 104, the client computer 106a, a docket system 810, the database 108, and an external database 808. The external database 808 is connected to the network 104 and system 102. Further, the system environment 800 includes the workflow engine 110. According to an embodiment of the present invention, the workflow engine 110 comprises an alert module 802, a form generator module 804, and a legal status alert module 806. The alert module 802 can alert a user regarding disclosure of IP documents to various IP offices. For example, the USPTO requires that the applicants disclose details of prior art known by the applicant within three months of filing the application or receiving the office action/search report in a foreign country. The alert module 802 includes a customizable rule-set that stores country specific guidelines of similar deadlines for relevant countries where the IP applications have been filed by the applicant. The alert module 802 is configured to send an automatic acknowledgement to the users placing requests for one or more IP documents. Further, the alert module 802 can keep a track of important dates, such as date of filing the US applications and date of receiving the office action/search report, and apply the rule-set to remind the users of upcoming deadlines. These important dates can be manually fed by prompting users while uploading documents/deliverables via upload module 224, an integral component of workflow engine 110. In another embodiment, alert module 802 connects with a docket system 810 via the network 104 to access these details. The reminder can be sent to predefined emails and can be shown on a home page of system environment 800 or even the docket system 810.

The form generator module 804 contains country-specific templates for IP information disclosure for one or more IP offices. A user may specify a docket number or application number of an IP application, and the form generator module 804 searches for all relevant prior art citations for the IP application. The user may confirm selection of the relevant prior art citations and, thereafter, the form generator 804 auto populates their citation details in the respective template. The form generator 804 can then send the filled form along with copies of the IP documents to the concerned user (an IP attorney or a paralegal) for filing with the respective IP office. In an embodiment, if the IP office supports online filing, the system 102 can directly submit the filled form (and copies of the IP documents) to the IP offices.

In another embodiment, system 102 can communicate with an external database 808 via the network 104. Examples of external database 808 could be a IP databases (such as United States Patent and Trademark Office (USPTO) PAIR or Espacenet) or a third-party database. The communication provides several possibilities to enhance functionalities of system environment 800. For example, after a user fills information required for order module 222 to request a copy of the IP document, upload module 224 can automatically validate the identity of the document (for example, by an automatic Internet search in the background), check the availability of the document, download the document from the PTO and third-party database, if available, and upload it to the database 108. In another embodiment, alert module 802 can automatically maintain and update its rule-set by checking with the external database 808.

The legal status alert module 806 can automatically check legal status of IP applications uploaded in the database 108 by querying the external database 808, and generate an alert if a new IP office communication has been issued for the IP application and if it needs to be included in the database 108. In an alternative embodiment, legal status alert module 806 may also automatically download the new IP office communication and upload it to the database 108. Further, the legal status alert module 806 is capable of generating an alert if a new IP office communication has been issued for IP applications.

In another embodiment, the system 102 can include an analytics module (not shown) that provides insights and recommendations based on the data stored in database 108. The analytics module can display inter-relationship between IP families (e.g. patent families) and their respective prior art citations using graphs. For example, a user may select a patent, and the analytics module can pictorially display references that were cited or incorporated by reference by the patent (backward citations), and the references that were cited or incorporated by reference by the patent (forward citations).

According to an embodiment of the present invention, system 102 can also be used for managing other forms of IP, such as trademarks, designs and utility models. All these forms of IP are also filed by IP applicants in multiple countries, and their filing/prosecution/maintenance involves filing and maintaining numerous documents.

Advantages of some embodiments of the present invention include online storage and retrieval of IP documents by different users within an organization, reducing duplicity of time and cost in obtaining the documents. The invention helps in maintaining an online searchable repository of all IP documents relevant to an applicant's IP portfolio worldwide. The present invention provides a workflow system, allowing users to submit orders for procuring prior art documents, ordering translation, review of IP office communications; and other formalities support. Further, the present invention keeps a track of country specific laws and deadlines for prior art disclosure and reminds the users when and where the prior art disclosure is due.

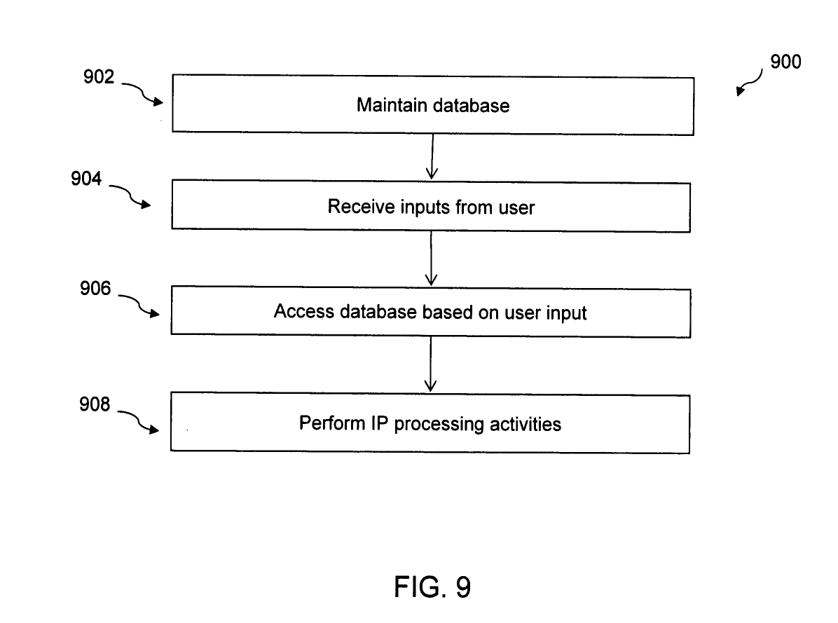

FIG. 9 illustrates a flowchart 900 illustrating a method for managing Intellectual Property prosecution.

The flowchart 900 is described in detail in conjunction with FIG. 1 and FIG. 2. The method initiates at step 902. At step 902, paralegals, clerks, and the users maintain the database 108 by storing IP documents, deliverables, and user requested documents. Database administrators store documents in a characterized fashion according to various tags and classifications for easy accessing, retrieving and searching. At step 904, workflow engine 110 receives input from one or more users, corresponding to the order module 222, the upload module 224, and the search module 226, through the user interface module 216. For example, the input received for order module 222 includes title, author, journal, date, document size. In another example, the input received for upload module 224 includes input specifies title, abstract, publication date, journal, docket-ID, attorney-on-record along with an electronic document. In yet another example, the input received for search module 226 includes search parameters, such as docket id, title, author, abstract, publication date, and country 704f. At step 906, the workflow engine 110 accesses the database 108 based on the type of inputs received (at step 904) from the users.

For example, for the order module 222 input, the requisite IP documents are identified based on the input. In another example, for the upload module 224 input, the inputted fields are filled with the file that needs to be uploaded. In yet another example, for the search module 226 input, the workflow engine 110 accesses the database 108 for searching the requisite details.

At step 908, workflow engine 110 performs the relevant IP functionalities in accordance with step 904 and 906. For the order data input, the workflow engine 110 accesses the database 108 and checks if the document is already available in the database 108. If the document is available, the document is displayed on the screen of client computer 106a to the user, who can then associate the document with a docket ID. If the document is not available, a request to procure the document is sent automatically to a paralegal at a back-end or directly to a document procurement vendor. The paralegal, after obtaining the copy of the document, may upload the copy of the document and fill the relevant metadata (such as docket id and relevant bibliographic information). In case of copyright restrictions, the paralegal can obtain necessary copyright license to upload the document with viewing/downloading rights restricted to the specified user(s) only. Moreover, a translated copy of the IP document can be ordered, if the document is not in the native language.

Additionally, the user may submit a PCT search report for a US patent application to identify any new prior art document. The paralegal, after receiving the request, identifies the prior arts listed in the search report and map them against the prior arts previously disclosed to the US patent office. Any new prior art thus identified may be reported to the user by the paralegal.

Further, when the input received from a user is for uploading of IP documents to the database 108, the workflow engine 110 uploads documents with corresponding identification details tags, such as title, abstract, publication date, journal names, docket id, attorney-on-record, country of publication, publication number, copyright status, and cost information. Further, the workflow engine 110 uploads one or more deliverables prepared on request basis for the preparation of formal documents or requests for reviewing of the IP office communication.

Furthermore, after the relevant inputs have been received for searching, results are displayed from the database 108. Workflow engine 110 searches for the stored classified documents in the database. Additionally, full-text searching inside the documents is performed on stored IP documents.

In the foregoing specification, specific embodiments have been described. However, one of ordinary skill in the art appreciates that various modifications and changes can be made without departing from the scope of the invention. Accordingly, the specification and figures are to be regarded in an illustrative sense rather than a restrictive sense, and all such modifications are intended to be included within the scope of the present teachings.

The system for IP prosecution management, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, and a display unit. The computer further comprises a microprocessor. The microprocessor is connected to a communication bus. The computer also includes a memory. The memory may include Random Access Memory (RAM) and Read Only Memory (ROM). The computer system also comprises a storage device, which can be a hard disk drive or a removable storage drive, such as a floppy disk drive, optical disk drive, etc. The storage device can also be other similar means for loading computer programs or other instructions into the computer system. The computer system also includes a communication unit, which allows the computer to connect to other databases and the Internet through an Input/Output (I/O) interface. The communication unit allows the transfer as well as reception of data from other databases. The communication unit may include a modem, an Ethernet card, or any similar device that enables the computer system to connect to databases and networks, such as Local Area Network (LAN), Metropolitan Area Network (MAN), Wide Area Network (WAN) and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of programmable or computer readable instructions may include various commands that instruct the processing machine to perform specific tasks, such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine. The programmable instructions can be stored and transmitted on computer readable medium. The programmable instructions can also be transmitted by data signals across a carrier wave. The disclosed invention can also be embodied in a computer program product comprising a computer readable medium, the product capable of implementing the above methods and systems, or the numerous possible variations thereof.

While various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention.

What is claimed is:

1. An Intellectual Property (IP) prosecution management system comprising:
a workflow engine configured to:
enable access to one or more IP documents stored in a database; and
facilitate online IP prosecution support based on the access of the one or more IP documents.

2. The Intellectual Property (IP) prosecution management system according to claim 1, wherein the workflow engine comprises:
an order module configured to order copy of the one or more IP documents, the copy being pre stored in the database;
an upload module configured to upload the one or more IP documents to the database; and
a search module configured to search and access the one or more IP documents in the database.

3. The Intellectual Property (IP) prosecution management system according to claim 2, wherein the order module is further configured to order copy of one or more IP documents, the copy being stored in the database subsequent to a request for procurement.

4. The Intellectual Property (IP) prosecution management system according to claim 2, wherein the order module is further configured to order one or more IP office communications to identify new IP documents.

5. The Intellectual Property (IP) prosecution management system according to claim 2, wherein the order module is further configured to order a preparation of formal documents that disclose one or more prior arts to a relevant IP office.

6. The Intellectual Property (IP) prosecution management system according to claim 2, wherein the upload module is further configured to upload one or more deliverables prepared on a request basis.

7. The Intellectual Property (IP) prosecution management system according to claim 2 wherein the search module is configured to provide input parameters to enable the search for the one or more IP documents in the database.

8. The Intellectual Property (1P) prosecution management system according to claim 7 wherein the input parameters include one or more of a docket-id, a title, an author, an abstract, a publication date, an inventor, an applicant, and a country.

9. The Intellectual Property (IP) prosecution management system according to claim 1, wherein the workflow engine further comprises:
an alert module configured to alert and send reminders to pre-set email-IDs of users regarding disclosure of the one or more IP documents and deadlines thereof to submit the one or more IP documents with one or more IP offices;
a form generator module configured to automatically generate country-specific templates for the one or more IP offices; and
a legal status alert module configured to automatically check legal status of IP applications uploaded on the database and generate an alert if a new IP office communication has been issued for the IP applications.

10. The Intellectual Property (IP) prosecution management system according to claim 9, wherein the alert module is further configured to send an automatic acknowledgement to the users placing order requests for the one or more IP documents.

11. The Intellectual Property (IP) prosecution management system according to claim 9, wherein the alert module comprises a customizable rule-set to track country-specific laws and corresponding deadlines to submit IP documents related to prior art disclosure.

12. A computer implemented method for Intellectual Property (IP) prosecution management, the method comprises steps of:
maintaining a database of one or more IP documents, the one or more IP documents comprises one or more IP deliverables;
accessing the database based on a user input; and
performing one or more IP processing activities associated with the one or more IP documents based on the user input.

13. The method of claim 12, wherein the performing of one or more IP processing activities comprise ordering a copy of the one or more IP documents, the copy already stored in the database placing an order for one or more IP office communications to identify new IP documents.

14. The method of claim 12, wherein the performing of one or more IP processing activities comprise ordering a copy of one or more IP documents, the copy stored in the database after a request for procurement.

15. The method of claim 12, wherein the performing of one or more IP processing activities comprise ordering a copy of one or more IP office communications to identify new IP documents.

16. The method of claim 12, wherein the performing of one or more IP processing activities comprise uploading the one or more IP documents to the database.

17. The method of claim 12, wherein the performing of one or more IP processing activities comprise uploading one or more deliverables to the database prepared on a request basis.

18. The method of claim 12, wherein the performing of one or more IP processing activities comprise searching and accessing the one or more IP documents from the database.

19. A computer program product for use with a computer, the computer program product comprising a tangible computer usable medium having a computer readable program code embodied therein for managing Intellectual Property (IP) prosecution, the computer readable program code comprising:
program instructions for maintaining a database of one or more IP documents;
program instructions for receiving a user input;
program instructions for accessing the database based on the user input; and
program instructions for performing one or more IP processing activities based on the user input;

20. The computer program product of claim 19, wherein program instructions comprise ordering a copy of the one or more IP documents, the copy already stored in the database placing an order for one or more IP office communications to identify new IP documents.

21. The computer program product of claim 19, wherein program instructions comprise ordering a copy of one or more IP documents, the copy stored in the database after a request for procurement.

22. The computer program product of claim 19, wherein program instructions comprise ordering a copy of one or more IP office communications to identify new IP documents.

23. The computer program product of claim 19, wherein program instructions comprise uploading the one or more IP documents to the database.

24. The computer program product of claim 19, wherein program instructions comprise uploading one or more deliverables to the database prepared on a request basis.

25. The computer program product of claim 19, wherein program instructions comprise searching and accessing the one or more IP documents from the database.
